(19) United States
(12) Patent Application Publication
(10) Pub. No.: US 2018/0170291 A1
(43) Pub. Date: Jun. 21, 2018

(54) Portable and cost-efficient transportation system with an integrated electric generator

(71) Applicant: Jubin Gorji, Fort Lauderdale, FL (US)

(72) Inventor: Jubin Gorji, Fort Lauderdale, FL (US)

(21) Appl. No.: 15/382,694

(22) Filed: Dec. 18, 2016

(51) Int. Cl. B60R 16/03; B62B 1/04; B60L 1/00; B62B 5/00; H02K 7/18

(52) U.S. Cl. CPC B60R 16/0307; B62B 1/04; H02K 7/1861; B62B 5/00; B60L 1/006

(57) ABSTRACT

A portable and cost-efficient transportation system with an integrated electric generator, capable of transporting various objects, while producing an electric current and sufficient quantities of electricity through the simultaneously created rotation of the device's wheels. The harvested electrical energy can then be stored in an integrated battery and utilized directly via an integrated power AC outlet socket, USB port and/or integrated lighting mechanism. The portable device encompasses collapsable features, such as a collapsible handle and base, for simplified transportation and employs efficient generators to generate a steady flow of electricity during usage of the device.

### BACKGROUND OF THE INVENTION

### 1. Field of the Invention

The present invention relates to the transportation of materials and the simultaneous production of electricity. More specifically, this invention relates to a portable and cost-efficient transportation system with an integrated electric generator, capable of transporting various objects, while producing an electric current and sufficient quantities of electricity, which is then stored in an integrated battery and possibly utilized directly via an integrated power AC outlet socket, USB port and/or integrated lighting mechanism.

### 2. Description of Related Art

Electricity is one of the most valuable and crucial components in communities around the globe. Although many regions around the world have been equipped with sophisticated electrical grids and reliable energy access, other regions encompassing approximately 17% of the world's population still lack elaborate infrastructure and access to clean, reliable and safe sources of energy. Whether these regions comprise rural and isolated communities that cannot be connected to national grids due to lack of financial resources, or modern ones, such as campsites, energy sources, such as fossil-fuel-based generators and traditional firewood, are often utilized for maintaining living conditions and providing the energy necessary to power essential electrical appliances and lighting.

However, many of these alternatives also have a detrimental range of drawbacks, that often destabilize the very safety and efficiency of communities and lead to unwanted pollution, and heavy financial burdens. The ongoing use of dangerous kerosene lamps in large parts of developing regions has especially jeopardized the very safety of individuals who rely on these methods for continued lighting. The increased use of fossil fuels and firewood not only produces unprecedented quantities of dangerous air pollutants, carbon dioxide, black carbon, and methane, but also leads to increased deforestation, soil erosion and the destruction of fragile ecosystems. Furthermore, current methods have put a heavy financial burden on communities and villages. Indirectly, the diversion of funds to such inefficient/expensive fuels can especially prevent families and communities from having sufficient funds for other essential elements, such as food and housing. Without access to healthy lighting sources, developing regions subsequently are deprived of economical development (expansion of business are halted due to high energy costs), and better living standards.

For example, a hand-powered generator is known in the art that produces electricity by converting mechanical energy created by the cranking of a device into electric energy for various uses, including lighting and charging purposes (when combined with an external apparatus). In relation to this generator, the present invention not only generates electricity, but does so by converting the excess mechanical energy from the wheels of the device into renewable energy. This system allows users to continue transporting materials, making it practical, while also allowing for the simultaneous production of electricity, which can directly be utilized through an integrated lighting mechanism, USB port and/or outlet. In addition, the present example is only for the sole purpose of generating electricity, while the present invention has multiple applications, functions and integrated capabilities.

There is a need in the art for a practical and portable device that has the capability of providing a reliable and sufficient source of electricity, while keeping renewability and safety in perspective. To keep renewability in mind, this device would capture the remarkable quantities of mechanical energy produced everyday by humans through incorporating an electricity-producing mechanism in a wheeled and portable transportation vehicle for small everyday loads. The present device would thus provide an easy-to-use and energy-producing apparatus that would allow individuals to carry loads, such as water and firewood, in a more efficient and facile manner, while generating sufficient quantities of electricity that would be capable of providing lighting and a reliable energy source for everyday life in developed as well as undeveloped regions alike.

### BRIEF SUMMARY OF THE INVENTION

Lacking reliable access to electricity is a major issue that impacts the lives of nearly 1.3 billion people around the globe. Without electricity, many individuals and communities cannot use pivotal electrical equipment and most importantly do not have access to lighting. The present invention seeks to alleviate this problem through providing a cost-effective, efficient and portable device that has the capability of providing a reliable source of electricity, while keeping renewability and cost-efficiency in perspective. The present invention embodies a functional and efficient transportation device that would be able to transport loads while producing sufficient quantities of electricity through the simultaneously created rotation of the device's wheels, which is then stored in an integrated battery and possibly utilized directly via an integrated power AC outlet socket, USB port and/or integrated lighting mechanism.

An object of the present invention is to provide a transportation system that can produce an electric current while simultaneously being able to transport various loads, ranging from raw materials to personal equipment.

Another object of the present invention is to provide a transportation system that can simultaneously act as a lighting source for the individual utilizing device via an integrated lighting mechanism.

A further object of the present invention is to provide a transportation system that can simultaneously act as a portable charging device for mobile devices via an integrated USB port and electric outlet.

Still another object of the present invention is to provide a transportation system that can be easily collapsed when needed and is easily portable, e.g., to possibly allow storage in a backpack or similar container.

Yet another object of the present invention is to provide a transportation system that is lightweight and easily transportable.

Other objects and advantages of the present invention will become apparent from he following descriptions, taken in connection with the accompanying drawings.

### BRIEF DESCRIPTION OF THE SEVERAL VIEWS OF THE DRAWING

For a fuller and better understanding of the invention, reference is made to the following detailed description, taken in connection with the accompanying drawings, in which:

FIG. 1 illustrates a front perspective view of the transportation system with an integrated electric generator, including the lighting mechanism, frame, wheels, and handle

FIG. 2 illustrates a perspective view from behind of the transportation system with an integrated electric generator, including the lighting mechanism, frame, wheels, and outlet

FIG. 3 illustrates a perspective view of the left side of the transportation system with an integrated electric generator, including the lighting mechanism, frame, wheels and base

FIG. 4 illustrates a perspective view of right side of of the transportation system with an integrated electric generator, including the lighting mechanism, frame, wheels and base

FIG. 5 illustrates a perspective view from above of the transportation system with an integrated electric generator, including the lighting mechanism, frame, wheels, base, and handle

FIG. 6 illustrates a perspective view from below of the transportation system with an integrated electric generator, including the lighting mechanism, frame, wheels, base, and handle

### DETAILED DESCRIPTION OF THE INVENTION

The present invention relates to a portable and cost-efficient transportation system with an integrated electric generator, capable of transporting various objects, while producing an electric current and sufficient quantities of electricity through the simultaneously created rotation of the device's wheels. The harvested electrical energy can then be used directly by the consumer via various electricity retrieval components, including, but not limited to, an integrated power AC outlet socket and/or universal USB port and/or integrated lighting, which can be used as a table lamp (when the device is turned vertically) or light-emitting device.

With all electrical generators, which work by means of electrical induction, the principle is the same: mechanical energy is converted to electric energy. In the present invention, the integrated generator utilizes the produced mechanical energy, which is delivered by the rotation of the wheels, to create electric energy.

In today's communities, there has been an increasing necessity for mobile energy (for the charging of laptops, tablets and mobile device). The present invention has the capability of harvesting energy that is produced unconsciously everyday and converts this energy into an easy-to-use format that allows for the charging of mobile devices. For instance, people who travel constantly and do not always have access to wall outlets are looking for a complete solution that is portable, mobile, and would allow then to transport, e.g., their luggage, while simultaneously generating the necessary energy for the loading of their electrical equipment. Additionally, large populations do not have access to reliable energy sources and the present invention serves as a means for renewable energy production.

The present invention is made up of a lightweight and compact structure that allows one to carry the device with ease and then (after it is expanded) use it as a trolley, table lamp, battery and a direct electricity generator.

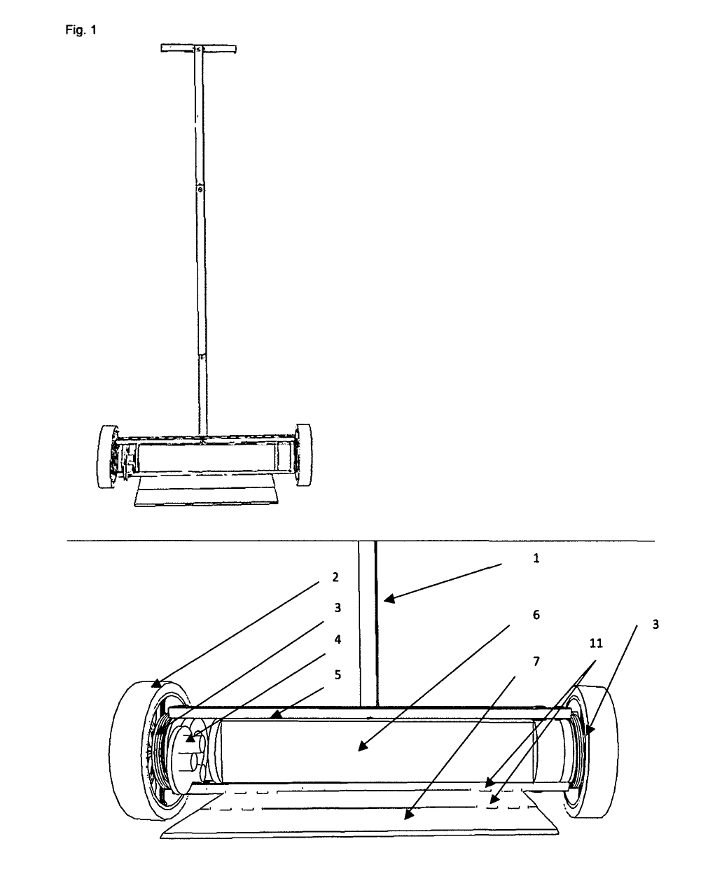

FIG. 1 fully illustrates the transportation system with an integrated electric generator, including the frame (5). By moving the wheels (2), the integrated electric generators generate (3) electrical energy. Located within the main compartment of the device (6) is a rechargeable lithium battery (or other forms of a battery or batteries) in which electric energy can be stored and used on demand via energy retrieval components, which may include a USB port (10) for the charging of electrical devices, such as mobile devices. The electrical energy can also be used directly to charge or operate electrical equipment when needed via an integrated power socket (9). The built-in LED light-emitting mechanism may also be used in the context of a table lamp (4). The base (7) is used to transport any required loads or materials, including, but not limited to suitcases, objects, bags, and other containers and objects. The handle (1) has a very compact design that allows the collapsing and expanding of the handle.

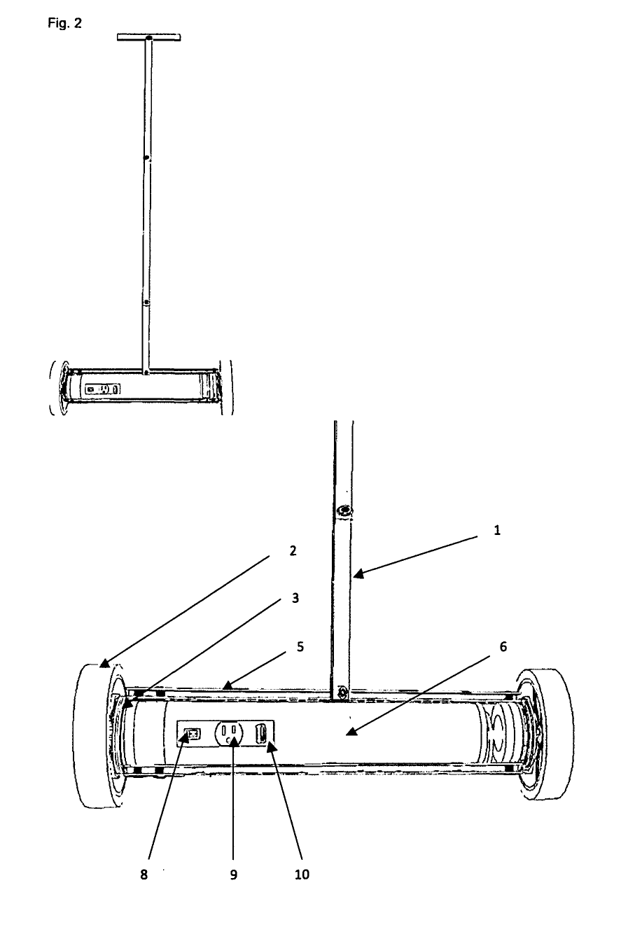

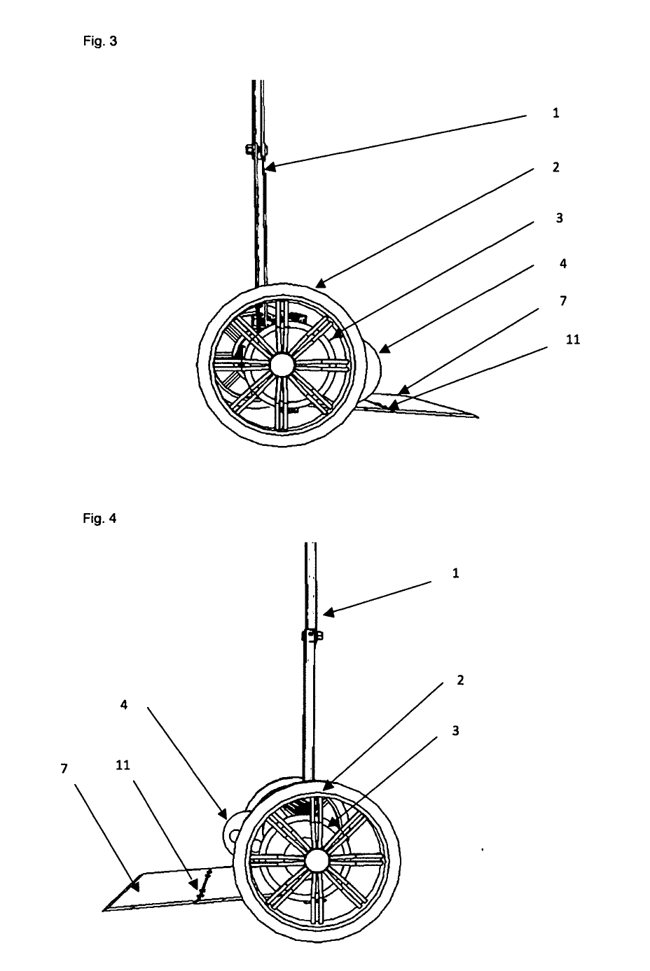

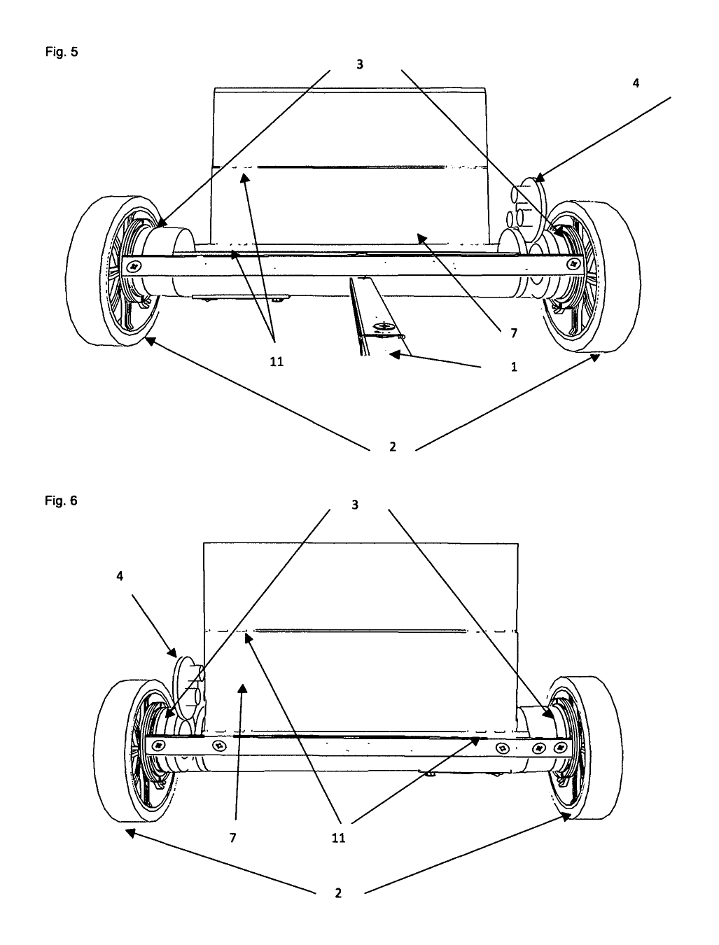

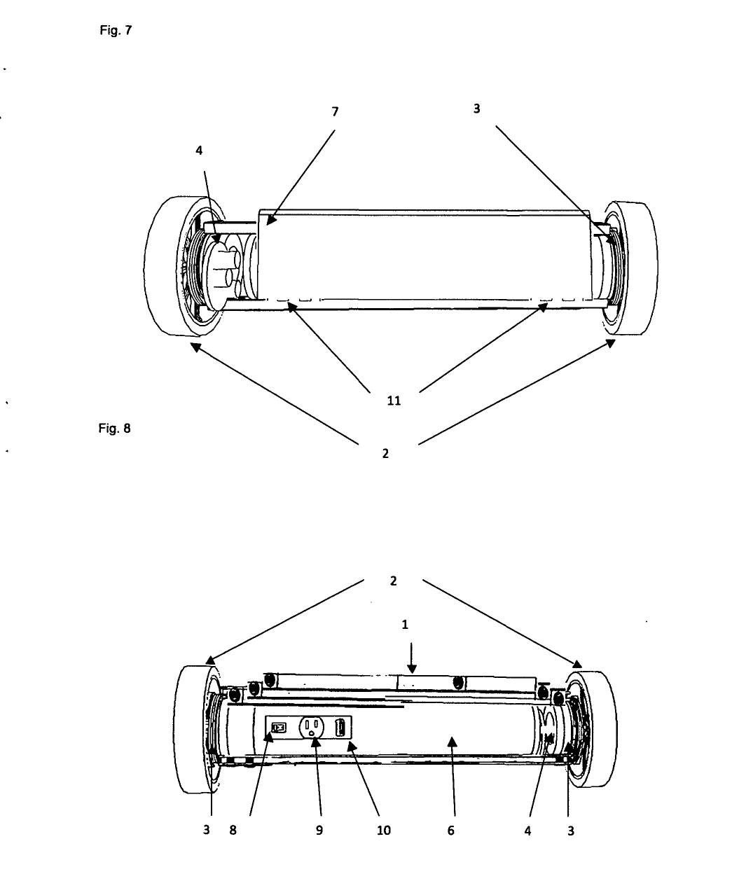

FIG. 2-6 illustrate various views of the transportation system with an integrated electric generator. The housing (6) and handle (1) may preferably be made of a material such as PVC, aluminum, metal, plastic, or any other natural or artificial material (known in the art), or a combination of these materials.

The structure of the electricity-producing transportation system first consists of a central body, which can be characterized by a stabilizing frame (5). Then, the middle component is comprised of an integrated and collapsible handle for providing handling and a support structure for the specific load. The wheels can either be directly or indirectly connected to the integrated generators (3), which through the rotation of the wheels (2) generate electric power. The transportation device also contains a compactable base for loads

The present invention is also eco-friendly and provides a portable/renewable energy source, since the generated electric power does not come from nuclear fission, or the burning of coal/fossil fuels, but from the movement of the integrated wheels of the transportation system.

The integrated generators can produce electrical power (110V-240V) (stored in integrated batteries) that may be directly used to charge external devices using an integrated AC socket (10) and/or USB port. The present invention then can also be used as means of transportation and/or a battery charger and/or lighting source. More specifically, the lighting source (4) may be utilized as a table lamp through turning the transportation device vertically (the wheels could act as a base).

The handle (1) and frame (5), preferably made of aluminum or any other material, may be used for stability purposes and handling. An integrated switch (8) can also be integrated for the running off and on of the lighting source (4).

Due to its compact and lightweight design and as a result of its modern and sleek frame, it provides a means of transportation, e.g. trolley, (for luggage, bags and other loads) on one hand and acts as a reliable energy-producing source on the other. The main/modular component of the device can also be integrated into suitcases that would have the same capability as a transportation device and thus can contain the integrated electric generators (and act as an electricity generator). As a result, the transportation device can also be comprised of multiple wheels for handling of heavier luggage, while still producing energy (electric generators, battery etc.) though the electric generators, which can also be motors or synchronous motors.

Although the above embodiments have been described in language that is specific to certain structures and methodological steps, it is to be understood that the invention defined in the appended claims is not necessarily limited to the specific structures and/or steps described. Rather, the specific aspects and steps are described as forms of implementing the claimed invention. Since many embodiments of the invention can be practiced without departing from the spirit and scope of the invention, the invention resides in the claims hereinafter appended.

1. A portable and cost-efficient transportation system with an integrated electric generator, capable of transporting various objects, while producing an electric current and sufficient quantities of electricity through the simultaneously created rotation of the device's wheels, comprising: a transportation system, wherein said transportation system is comprised of a lightweight, portable, and collapsible structure; an integrated electric generator for generating electricity; one or more electricity retrieval components, wherein said electricity retrieval components comprise a USB port power outlet and lighting mechanism; and an integrated electricity storage component for storing the generated electricity from said electric generator.

2. The portable and cost-efficient transportation system with an integrated electric generator as recited by claim 1, wherein said transportation system allows for the transportation of various objects, including, but not limited to, personal objects, equipment, raw materials, suitcases and other transportable containers and materials.

3. The portable and cost-efficient transportation system with an integrated electric generator as recited by claim 2, wherein said transportation system is easily portable or achieves a facilitated transportation through a collapsible and expandable design.

4. The portable and cost-efficient transportation system with an integrated electric generator as recited by claim 1, wherein said portable and collapsible structure comprises a collapsible and expandable base that serves to hold the preferred load and/or object, and a collapsible and expandable handle that allows individuals to pull/move the device manually

5. The portable and cost-efficient transportation system with an integrated electric generator as recited by claim 4, wherein said collapsible and expandable handle folds within itself to form a smaller structure that is more portable in comparison to the original extendable handle

6. The portable and cost-efficient transportation system with an integrated electric generator as recited by claim 1, wherein said integrated electric generator is located within the device or preferably at or near the wheels of the device to allow for the maximal conversion of mechanical energy to electric energy

7. The portable and cost-efficient transportation system with an integrated electric generator as recited by claim 6, wherein said integrated electric generator is comprised of several individual generators or a single generator, which are connected to the wheel(s) of the device

8. The portable and cost-efficient transportation system with an integrated electric generator as recited by claim 1, wherein said electricity retrieval components provide a means of retrieval of the harvested electricity

9. The portable and cost-efficient transportation system with an integrated electric generator as recited by claim 8, wherein said electricity retrieval components, include, but are not limited to, USB port power outlets and lighting mechanism

10. The portable and cost-efficient transportation system with an integrated electric generator as recited by claim 1, wherein said electricity retrieval components are integrated into the device to provide maximal portability or may be connected externally

11. The portable and cost-efficient transportation system with an integrated electric generator as recited by claim 1, wherein said electricity storage component is integrated in the device or can take on a modular form allowing for the storage of harvested electricity

12. The portable and cost-efficient transportation system with an integrated electric generator as recited by claim 1, wherein said transportation system may be preferably in the form of a trolley, handcart, transportation mechanism for loads, or any other mechanism, method and/or system that allows for the transportation of objects and materials of various sizes and shapes

13. A portable and collapsible transportation system with an integrated electric generator, capable of transporting various objects and loads, while simultaneously producing an electric current through the conversion of mechanical energy to electric energy, comprising: a transportation system with an integrated electric generator, wherein said transportation system is comprised of a lightweight, portable, and collapsible structure; an integrated electric generator for generating the necessary electricity; one or more electricity retrieval components, wherein said electricity retrieval components comprise a USB port power outlet and lighting mechanism and an integrated electricity storage component for storing the generated electricity from said electric generator.
